(19) United States
(12) Patent Application Publication
(10) Pub. No.: US 2007/0083013 A1
(43) Pub. Date: Apr. 12, 2007

(54) Dip-forming composition, dip-formed article and process for making same

(76) Inventors: Hisanori Ota, Tokyo (JP); Tomomi Onitake, Tokyo (JP); Kazumi Kodama, Tokyo (JP)

Correspondence Address: BIRCH STEWART KOLASCH & BIRCH, PO BOX 747, FALLS CHURCH, VA, 22040-0747, US

(21) Appl. No.: 11/634,838

(22) Filed: Dec. 7, 2006

Related U.S. Application Data
(62) Division of application No. 10/509,064, filed on Sep. 24, 2004.

(30) Foreign Application Priority Data
Mar. 27, 2002 (JP) 2002-88959

(51) Int. Cl. C08F 236/00

(52) U.S. Cl. 525/329.3; 524/556; 524/565; 524/566; 525/332.4

(57) ABSTRACT

A dip-forming composition comprising a conjugated diene rubber latex prepared by copolymerizing 30-90 wt. % of a conjugated diene monomer, 0.1-20 wt. % of an ethylenically unsaturated acid monomer and 0-69.9 wt. % of other copolymerizable ethylenically unsaturated monomer, wherein a copolymer constituting the conjugated diene rubber latex exhibits a content insoluble in methyl ethyl ketone of not larger than 30 wt. % at a latex pH value of 10, and the dip-forming composition has a pH value of at least 8.5 and is substantially free from a sulfur-containing vulcanizer, a vulcanization accelerator for the sulfur-containing vulcanizer, and zinc oxide. A dip-formed article made therefrom, which has been crosslinked with a water-soluble polyvalent metal salt used as a coagulant for latex, has an extremely reduced number of pinholes, good softness to touch, high tensile strength and high fatigue resistance to repeated use.

### TECHNICAL FIELD

This application is a Divisional of co-pending application Ser. No. 10/509,064 filed on Sep. 24, 2004, and for which priority is claimed under 35 U.S.C. § 120. Application Ser. No. 10/509,064 is the national phase of PCT International Application No. PCT/PCT/JP03/03887 filed on Mar. 27, 2003 under 35 U.S.C. § 371. The entire contents of each of the above-identified applications are hereby incorporated by reference. This application also claims priority of Application No. 2002-88959 filed in Japan on Mar. 27, 2002 under 35 U.S.C. § 119.

This invention relates to a dip-forming composition, a dip-formed article, and a process for making the dip-formed article. More specifically, it relates to a dip-forming composition used as a raw material for making a dip-formed article having an extremely reduced number of pinholes, good softness of touch and comfortable fittingness to wear, a high tensile strength and good fatigue resistance to repeated wearing; the dip-formed article; and a process for making the dip-formed article with enhanced efficiency.

### BACKGROUND ART

Rubber gloves are widely used for household uses, industrial uses in, for example, food industry and electronic part industry, and surgical and other medical uses. It is generally required for rubber gloves that they are substantially pinhole-free, they have good softness of touch and they are well-fitting and comfortable to wear, namely, they are capable of being easily stretched in conformity with movement of fingers so that fatigue does not itself felt even when they are worn for long hours; that they are not easily broken, namely, they have a high tensile strength; and further that, even when fingers are moved continually for long hours, fine cracks do not occur at finger crotches, namely, they have good fatigue resistance to repeated use.

Rubber gloves made by dip-forming natural rubber latex have widely been used, but, allergies to natural rubber sometimes cause rashes or itching due to protein contained in a slight amount in natural rubber.

Rubber gloves made by dip-forming a synthetic rubber latex, for example, an acrylonitrile-butadiene copolymer latex, are known. Allergy does not develop to rubber gloves made from the synthetic rubber latex.

More specifically, for example, U.S. Pat. No. 2,880,189 discloses a dip-forming composition comprising a specific carboxyl-modified acrylonitrile-butadiene copolymer latex having been neutralized with ammonia, and a water-insoluble polyvalent metal oxide. This dip-forming composition gives a dip-formed article to which allergy does not or does develop only to a negligible extent. But, the dip-formed article has a low tensile strength and poor fatigue resistance to repeated use, and therefore, it is easily broken during wearing, and fine cracks are liable to occur in finger crotches when fingers are moved continually for long hours.

International publication WO 00/21451 discloses gloves made by dip-forming a composition comprising an acrylonitrile-butadiene copolymer latex containing a specific amount of a carboxyl group, an extremely slight amount of zinc oxide, a relatively large amount of sulfur and a vulcanization accelerator. These gloves tend to exhibit poor balance between the softness of touch or comfortable fittingness and the tensile strength or fatigue resistance to repeated use.

As explained above, gloves made of an acrylonitrile-butadiene copolymer latex are advantageous in that they do not have problem of allergies as observed to natural rubber due to protein contained in a slight amount in natural rubber. But, even when the gloves have high tensile strength, they tend to possess poor fatigue resistance to repeated use, and fine cracks are liable to occur in finger crotches even in relatively short hours.

### DISCLOSURE OF THE INVENTION

In view of the foregoing, an object of the present invention is to provide a dip-formed article which is pinhole-free and has good softness of touch and comfortable fittingness, high tensile strength, and good fatigue resistance to repeated use.

Another object of the present invention is to provide a dip-forming composition capable of giving the above-mentioned dip-formed article.

A further object of the present invention is to provide a process for producing the above-mentioned dip-formed article with enhanced efficiency.

The inventors made an extensive research to achieve the above-mentioned objects, and have found that a dip-formed article having the above-mentioned beneficial properties can be obtained without use of a conventional sulfur-containing vulcanizer and a vulcanization accelerator from a dip-forming composition having a specific pH value and comprising rubber latex of a conjugated diene copolymer having ethylenically unsaturated acid monomer units and exhibiting a reduced content of insoluble matter in methyl ethyl ketone. Based on this finding, the present invention has been completed.

In one aspect of the present invention, there is provided a dip-forming composition comprising a conjugated diene rubber latex prepared by copolymerizing, based on the weight of total monomers, 30 to 90% by weight of a conjugated diene monomer, 0.1 to 20% by weight of an ethylenically unsaturated acid monomer and 0 to 69.9% by weight of other ethylenically unsaturated monomer copolymerizable therewith, wherein a copolymer constituting the conjugated diene rubber latex exhibits a content insoluble in methyl ethyl ketone of not larger than 30% by weight at a latex pH value of 10, and the dip-forming composition has a pH value of at least 8.5 and is substantially free from a sulfur-containing vulcanizer, a vulcanization accelerator for the sulfur-containing vulcanizer, and zinc oxide.

In another aspect of the present invention, there is provided a dip-formed article made from the above-mentioned dip-forming composition, which article has been crosslinked with a water-soluble polyvalent metal salt used as a coagulant for latex, and has been prepared without substantial use of a sulfur-containing vulcanizer, a vulcanization accelerator for the sulfur-containing vulcanizer, and zinc oxide.

In a further aspect of the present invention, there is provided a process for making a dip-formed article comprising the steps of: (1) forming a dip-formed layer on a dip-forming form from the above-mentioned dip-forming composition by carrying out (i) at least one step of dipping a dip-forming form in a liquid containing a water-soluble polyvalent metal salt as a coagulant for latex, to form a layer comprised of the coagulant-containing liquid on the form, and then, dipping the form having the coagulant-containing liquid thereon in said dip-forming composition; or (ii) at least one step of dipping a dip-forming form in said dip-forming composition to form a layer of the dip-forming composition on the form, and then, dipping the form having the layer of the dip-forming composition thereon in a liquid containing a water-soluble polyvalent metal salt as a coagulant for latex; or (iii) a combination of said step (i) with said step (ii); (2) drying the dip-formed layer formed on the form; and then, (3) releasing the thus-dried dip-formed layer from the form.

### BEST MODE FOR CARRYING OUT THE INVENTION

The invention will now be described in detail.

Conjugated Diene Rubber Latex

The conjugated diene rubber latex used in the present invention is a copolymer rubber latex prepared by copolymerizing a conjugated diene monomer with an ethylenically unsaturated acid monomer, wherein a copolymer constituting the conjugated diene rubber latex exhibits a content insoluble in methyl ethyl ketone (hereinafter abbreviated to “MEK” when appropriate) of not larger than 30% by weight at a latex pH value of 10.

More specifically the conjugated diene rubber latex is a copolymer latex prepared by copolymerizing, based on the weight of total monomers, 30 to 90% by weight of a conjugated diene monomer, 0.1 to 20% by weight of an ethylenically unsaturated acid monomer and 0 to 69.9% by weight of other ethylenically unsaturated monomer copolymerizable therewith (this copolymer latex is hereinafter referred to as “copolymer latex” when appropriate).

The conjugated diene monomer is not particularly limited, and, as specific examples thereof, there can be mentioned 1,3-butadiene, isoprene, 2,3-dimethyl-1,3-butadiene, 2-ethyl-1,3-butadiene, 1,3-pentadiene and chloroprene. Of these, 1,3-butadiene and isoprene are preferable. These conjugated diene monomers may be used either alone or as a combination of at least two thereof.

The amount of conjugated diene monomer is in the range of 30 to 90% by weight, preferably 40 to 85% by weight and more preferably 50 to 80% by weight, based on the weight of total monomers. If the amount of conjugated diene monomer is too small, the dip-formed article is not satisfactory in softness of touch and comfortable fittingness. In contrast, if the amount of conjugated diene monomer is too large, the dip-formed article tends to have poor shape retention and low tensile strength.

The ethylenically unsaturated acid monomer includes ethylenically unsaturated monomers having an acidic group such as a carboxyl group, a sulfonic acid group or an acid anhydride group. As specific examples of the ethylenically unsaturated acid monomer, there can be mentioned ethylenically unsaturated monocarboxylic acid monomers such as acrylic acid and methacrylic acid; ethylenically unsaturated polycarboxylic acid monomers such as itaconic acid, maleic acid and fumaric acid; ethylenically unsaturated polycarboxylic acid anhydride monomers such as maleic anhydride and citraconic anhydride; ethylenically unsaturated sulfonic acid monomers such as styrenesulfonic acid; and ethylenically unsaturated polycarboxylic acid partial ester monomers such as monobutyl fumarate, monobutyl maleate and mono-2-hydroxypropyl maleate. Of these, ethylenically unsaturated carboxylic acid monomers are preferable. Ethylenically unsaturated monocarboxylic acid monomers are more preferable. Methacrylic acid is especially preferable. These ethylenically unsaturated acid monomers may be used in the form of a salt such as an alkali metal salt or an ammonium salt. The ethylenically unsaturated acid monomers may be used either alone or as a combination of at least two thereof.

The amount of ethylenically unsaturated acid monomer is in the range of 0.1 to 20% by weight, preferably 1 to 15% by weight and more preferably 2 to 6% by weight, based on the weight of total monomers. If the amount of ethylenically unsaturated acid monomer is too small, the dip-formed article has low tensile strength. In contrast, if the amount of ethylenically unsaturated acid monomer is too large, the dip-formed article is not satisfactory in softness of touch and comfortable fittingness.

As specific examples of the other copolymerizable ethylenically unsaturated monomers which are optionally used, there can be mentioned ethylenically unsaturated nitrile monomers such as acrylonitrile, methacrylonitrile, fumaronitrile, α-chloroacrylonitrile and α-cyanoethylacrylonitrile; vinyl aromatic monomers such as styrene, alkylstyrenes and vinyl naphthalene; fluoroalkyl vinyl ether monomers such as fluoroethyl vinyl ether; ethylenically unsaturated amide monomers such as acrylamide, N-methylolacrylamide, N,N-dimethylolacrylamide, N-methoxymethylacrylamide, N-propoxymethylacrylamide, methacrylamide, N-methylolmethacrylamide, N,N-dimethylol-methacrylamide, N-methoxymethylmethacrylamide and N-propoxymethylmethacrylamide; ethylenically unsaturated carboxylic acid ester monomers such as methyl acrylate, ethyl acrylate, butyl acrylate, 2-ethylhexyl acrylate, trifluoroethyl acrylate, tetrafluropropyl acrylate, methoxymethyl acrylate, ethoxyethyl acrylate, methoxyethoxyethyl acrylate, cyanomethyl acrylate, 2-cyanoethylacrylate, 1-cyanopropylacryalte, 2-ethyl-6-cyanohexyl acrylate, 3-cyanopropyl acrylate, hydroxyethyl acrylate, hydroxypropyl acrylate, glycidyl acrylate, dimethylaminoethyl acrylate, methyl methacrylate, ethyl methacrylate, butyl methacrylate, 2-ethylhexyl methacrylate, trifluoroethyl methacrylate, tetrafluropropyl methacrylate, methoxymethyl methacrylate, ethoxyethyl methacrylate, methoxyethoxyethyl methacrylate, cyanomethyl methacrylate, 2-cyanoethyl methacrylate, 1-cyanopropyl methacryalte, 2-ethyl-6-cyanohexyl methacrylate, 3-cyanopropyl methacrylate, hydroxyethyl methacrylate, hydroxypropyl methacrylate, glycidyl methacrylate, dimethylaminoethyl methacrylate, dibutyl maleate, dibutyl fumarate and diethylmaleate; and crosslinking monomers such as divinylbenzene, polyethylene glycol diacrylate, polyethylene glycol dimethacrylate, polypropylene glycol diacrylate, polypropylene glycol dimethacrylate, trimethylolpropane triacrylate, trimethylolpropane trimethacrylate, pentaerithritol acrylate and pentaerithritol methacrylate. Of these, ethylenically unsaturated nitrile monomers are preferable. Acrylonitrile is especially preferable. These optional ethylenically unsaturated monomers may be used either alone or as a combination of at least two thereof.

The amount of the optional ethylenically unsaturated monomer is 0 to 69.9% by weight, preferably 0 to 59% by weight and more preferably 14 to 48% by weight, based on the weight of total monomers. If the amount of the optional ethylenically unsaturated monomer is too large, the dip-formed article is liable to have poor softness of touch and comfortable fittingness.

A preferable monomer composition for the conjugated diene rubber latex comprises, based on the weight of total monomers, 40 to 79% by weight, more preferably 54 to 73% by weight, of 1,3-butadiene, 1 to 15% by weight, more preferably 2 to 6% by weight, of methacrylic acid and 20 to 45% by weight, more preferably 25 to 40% by weight, of acrylonitrile.

A copolymer constituting the above-mentioned conjugated diene rubber latex at a latex pH of 10 has a content insoluble in methyl ethyl ketone (MEK) of not larger than 30% by weight, preferably not larger than 20% by weight and more preferably not larger than 10% by weight, based on the weight of copolymer. If the insoluble content is too large, the dip-formed article has poor fatigue resistance to repeated use.

In the present invention, a single conjugated diene rubber latex having the above-mentioned MEK insoluble content can be used. Alternatively, a mixture of two or more kinds of conjugated diene rubber latexes can be used provided that the mixture has the above-mentioned MEK insoluble content

The conjugated diene rubber latex used in the present invention is obtained preferably by an emulsion copolymerization procedure.

The emulsifier used for emulsion copolymerization is not particularly limited, and, as specific examples thereof, there can be mentioned nonionic emulsifiers such as polyoxyethylenealkyl ethers, polyoxyethylene alkyl phenol ethers, polyoxyethylene alkyl esters and polyoxyethylene sorbitan alkyl esters; anionic emulsifiers such as salts of fatty acids, for example, myristic acid, palmitic acid, oleic acid and linolenic acid, alkylbenzenesulfonic acid salts, for example, sodium dodecylbenzenesulfonate, and higher alcohol sulfuric acid ester salts and alkylsulfosuccinic acid salts; cationic emulsifiers such as alkyltrimethylammonium chloride, dialkylammonium chloride and benzylammonium chloride; and copolymerizable emulsifiers such as sulfoesters of α, β-unsaturated carboxylic acids, sulfate esters of α, β-unsaturated carboxylic acids and sulfoalkyl aryl ethers. Of these, anionic emulsifiers are preferable. These emulsifiers may be used either alone or as a combination of at least two thereof. The amount of emulsifier is usually in the range of 1 to 10 parts by weight, preferably 2 to 6 parts by weight, based on 100 parts by weight of the total monomers added.

The polymerization initiator used is not particularly limited, and, as specific examples thereof, there can be mentioned inorganic peroxides such as sodium persulfate, potassium persulfate, ammonium persulfate, potassium perphosphate and hydrogen peroxide; organic peroxides such as diisopropylbenzene hydroperoxide, cumene hydroperoxide, tert-butyl hydroperoxide, 1,1,3,3-tetramethylbutyl hydroperoxide, 2,5-dimethylhexane-2,5-dihydroperoxide, di-tert-butyl hydroperoxide, di-α-cumyl peroxide, acetyl peroxide, isobutyryl peroxide and benzoyl peroxide; and azo compounds such as azobisisobutyronitrile, azobis-2,4-dimethylvaleronitrile and methyl azobisisobutyrate. Of these, inorganic peroxide polymerization initiators are preferable because a conjugated diene rubber latex can be stably produced. These polymerization initiators may be used either alone or as a combination of at least two thereof. The amount of polymerization initiator varies depending upon the particular kind of polymerization initiator used, but is usually in the range of 0.1 to 1 part by weight based on 100 parts by weight of the total monomers added.

The peroxide polymerization initiator can be used in combination with a reducing agent, as a redox polymerization initiator. The reducing agent used is not particularly limited and includes, for example, compounds containing a metal ion in a reduced state such as ferrous sulfate and cuprous naphthenate; sulfonic acid compounds such as sodium methanesulfonic acid; and amine compounds such as dimethylaniline. These reducing agents may be used either alone or in combination. The amount of reducing agent varies depending upon the particular kind of reducing agent used, but is usually in the range of about 0.03 to 10 parts by weight based on 1 part by weight of peroxide.

To obtain a copolymer having a desired content soluble in methyl ethyl ketone (MEK) by emulsion polymerization, a molecular weight modifier is preferably used. As specific examples of the molecular weight modifier, there can be mentioned mercaptans such as n-butyl mercaptan and tert-dodecyl mercaptan; sulfides such as tetraethylthiuram sulfide and dipentamethylenethiuram hexasulfide; and α-methylstyrene dimer and carbon tetrachloride. Of these, mercaptans are preferable. tert-dodecyl mercaptan is especially preferable. These molecular weight modifiers may be used either alone or as a combination of at least two thereof. The amount of molecular weight modifier can be appropriately chosen so as to obtain a copolymer having a desired content soluble in MEK, but is preferably in the range of 0.1 to 5 parts by weight and more preferably 0.2 to 4 parts by weight, based on the weight of total momnomers.

The procedure by which the molecular weight modifier is added is not particularly limited, and includes, for example, a procedure wherein the molecular weight modifier is added at one time into a polymerization system; a procedure wherein the molecular weight modifier is continuously added into a polymerization system; and a procedure wherein a part of the molecular weight modifier is added into a polymerization system prior to commencement of polymerization, and the remainder thereof is added after commencement of polymerization. Of these, the procedure wherein a part of the molecular weight modifier is added prior to commencement of polymerization, and the remainder thereof is added after commencement of polymerization, is preferable. This is because a copolymer having a desirably low MEK-soluble content and giving a dip-formed article having well balanced properties can easily be obtained.

In the process wherein a part of the molecular weight modifier is added into a polymerization system before commencement of polymerization, and the remainder of the molecular weight modifier is added to the polymerization system after commencement of polymerization, the amount of molecular weight modifier added before commencement of polymerization is preferably in the range of 40 to 95% by weight, more preferably 45 to 90% by weight and especially preferably 50 to 70% by weight, based on the total amount of molecular weight modifier.

It is preferable that the remainder of molecular weight modifier is added to a polymerization system when the polymerization conversion within the polymerization system is in the range of 50 to 95%, more preferably 55 to 90% by weight and especially preferably 50 to 70% by weight. This is because a dip-formed article having good and balanced softness of touch, comfortable fittingness, and good fatigue resistance to repeated use can be obtained. The remainder of molecular weight modifier added after commencement of polymerization can be added either at one time or in lots.

The amount of water used for emulsion polymerization is usually in the range of 80 to 600 parts by weight, preferably 100 to 200 parts by weight, based on 100 parts by weight of the amount of total monomers.

Polymerization auxiliaries can be used for emulsion copolymerization according to the need, which include, for example, a particle size modifier, a chelating agent and an oxygen scavenger.

The procedure by which the monomers are added is not particularly limited, and includes, for example, a procedure wherein the monomers are added at one time into a polymerization system; a procedure wherein the monomers are continuously added into a polymerization system; and a procedure wherein a part of the monomers are added into a polymerization system prior to commencement of polymerization, and the remainder thereof is added continuously after commencement of polymerization.

The polymerization temperature is usually in the range of 0 to 95° C., preferably 5 to 50° C. and more preferably 5 to 45° C. The polymerization time is usually in the range of about 5 to 40 hours.

The polymerization conversion at which the polymerization reaction is terminated is preferably in the range of 90 to 98% by weight, more preferably 92 to 95% by weight. When the polymerization reaction is terminated at a too low polymerization conversion, the productivity of copolymer latex is reduced. In contrast, when the polymerization reaction is terminated at a too high polymerization conversion, the content insoluble in MEK tends to become difficult to control to a desired value.

The copolymer latex prepared by emulsion polymerization preferably has a number average particle diameter in the range of 60 to 300 nm, more preferably 80 to 150 nm, as measured by a transmission electron microscope. The particle diameter can be adjusted to a desired value by varying the amounts of an emulsifier and polymerization initiator.

The polymerization reaction is terminated at a desired polymerization conversion, for example, by adding a polymerization stopper, unreacted monomers are removed from a polymerization mixture and the solid content and pH value thereof are adjusted according to the need to give a desired copolymer latex.

Dip-Forming Composition

The dip-forming composition of the present invention comprises the above-mentioned dip-forming latex, has a pH value of at least 8.5, preferably in the range of 9.5 to 13 and more preferably 10.5 to 12, and is substantially free from a sulfur-containing vulcanizer, a vulcanization accelerator for the sulfur-containing vulcanizer, and zinc oxide.

If the pH value of the dip-forming composition is lower than 8.5, the dip-formed article has poor tensile strength. It is usually difficult to adjust the pH to a value higher than 13.

To adjust the pH value of the dip-forming composition to the desired value, a basic substance is usually added. As specific examples of the basic substance, there can be mentioned alkali metal hydroxides such as lithium hydroxide, sodium hydroxide and potassium hydroxide; alkali metal carbonate salts such as sodium carbonate and potassium carbonate; alkali metal hydrogencarbonate salts such as sodium hydrogencarbonate; ammonia; and organic amine compounds such as trimethylammonium and triethanolamine. Of these, alkali metal hydroxides and ammonia are preferable. Alkali metal hydroxides are especially preferable. Potassium hydroxide is most preferable. These basic substances may be used either alone or in combination. To avoid occurrence of agglomerates at the addition of basic substance, the basic substance is added usually in the form of a solution, preferably an aqueous solution having a concentration of 1 to 40% by weight, preferably 2 to 15% by weight. The procedure by which the pH value of the dip-forming composition is adjusted is not particularly limited provided that the desired pH value can be obtained. For example, the pH value can be adjusted either before or after ingredients are incorporated in the conjugated diene rubber latex.

The sulfur-containing vulcanizing agent as used in the present invention means sulfur or a sulfur-containing compound capable of crosslinking polymer chains of conjugated diene rubber to form a network structure. The sulfur-containing vulcanizing agents are classified into inorganic sulfur-containing vulcanizing agents and organic sulfur-containing vulcanizing agents. The inorganic sulfur-containing vulcanizing agent includes, for example, sulfur such as powdery sulfur, flower of sulfur, oxygen-free sulfur, precipitated sulfur, colloidal sulfur, polymeric sulfur and insoluble sulfur, and sulfur monochloride. The organic sulfur-containing vulcanizing agent includes, for example, those which are capable of releasing active sulfur by thermal dissociation, such as morpholine disulfide and alkylphenol disulfide. Other specific examples of the organic sulfur-containing vulcanizing agent are listed in “Rubber Industry Manual”, fourth edition, III Chemical Ingredients, 1. Vulcanizing Agents, edited by Japan Rubber Association, published by Japan Rubber Association in January, 1994.

If the dip-forming composition contains a moderate amount of the sulfur-containing vulcanizing agent, the resulting dip-formed article has many pin-holes. By the term “substantially free from a sulfur-containing vulcanizing agent” as used herein, we mean that the sulfur-containing vulcanizing agent is preferably not contained at all, or is contained in an amount of usually not larger than 0.4 part by weight, preferably not larger than 0.2 part by weight and more preferably not larger than 0.1 part by weight, based on 100 parts by weight of the solid content of the conjugated diene rubber latex.

By the term “vulcanization accelerator for the sulfur-containing vulcanizing agent” as used herein we mean a substance having a function of accelerating a vulcanization reaction in the presence of the sulfur-containing vulcanizing agent, and thus, achieving shortening of vulcanization time, lowering of vulcanization temperature and reduction in amount of sulfur-containing vulcanizing agent. As specific examples of the vulcanization accelerator, there can be mentioned thiazole type vulcanization accelerators such as zinc salt of 2-mercaptobenzothiazole, thiourea type vulcanization accelerators such as diphenylthiourea, guanidine type vulcanization accelerators such as diphenylguanidine, and aldehydeammonia and aldehydeamine type vulcanization accelerators such as hexamethylenetetramine. Other specific examples of the vulcanization accelerator are listed in “Rubber Industry Manual”, fourth edition, III Chemical Ingredients, 3. Vulcanization Accelerators, edited by Japan Rubber Association, published by Japan Rubber Association in January, 1994.

If the dip-forming composition contains a moderate amount of the vulcanization accelerator for the sulfur-containing vulcanizing agent, the resulting dip-formed article has many pin-holes. By the term “substantially free from a vulcanization accelerator for the sulfur-containing vulcanizing agent” as used herein, we mean that the vulcanization accelerator is preferably not contained at all, or is contained in an amount of usually not larger than 0.4 part by weight, preferably not larger than 0.2 part by weight and more preferably not larger than 0.1 part by weight, based on 100 parts by weight of the solid content of the conjugated diene rubber latex.

If the dip-forming composition contains a moderate amount of zinc oxide, the resulting dip-formed article has many pin-holes. By the term “substantially free from zinc oxide” as used herein, we mean that the zinc oxide is preferably not contained at all, or is contained in an amount of usually not larger than 0.7 part by weight, preferably not larger than 0.3 part by weight and more preferably not larger than 0.1 part by weight, based on 100 parts by weight of the solid content of the conjugated diene rubber latex.

The total solid content in the dip-forming composition of the present invention is usually in the range of 5 to 50% by weight, preferably 10 to 45% by weight and more preferably 20 to 40% by weight. If the total solid content is too small, a dip-formed article having a desired thickness is difficult to obtain. In contrast, the total solid content is too large, the dip-forming composition is too viscous and difficult to handle, and the dip-formed article has non-uniform thickness.

Conventional ingredients such as an antioxidant, a dispersant, a thickener, a pigment, a filler and a softener may be incorporated in the dip-forming composition, according to the need. Proved that the object of the present invention is achieved, other latex such as natural rubber latex and isoprene rubber latex can be incorporated in the dip-forming latex.

There is no need of aging the dip-forming latex of the present invention, which is in contrast to the conventional dip-forming rubber latex. That is, a dip-formed article having high tensile strength can be obtained even without aging, and thus, its manufacture is easy.

Dip-Formed Article and Process for Making the Same

The dip-formed article of the present invention is made by dip-forming the above-mentioned dip-forming composition, which has been crosslinked with a water-soluble polyvalent metal salt used as a coagulant for latex, and has been prepared without substantial use of a sulfur-containing vulcanizer, a vulcanization accelerator for the sulfur-containing vulcanizer, and zinc oxide.

The dip-formed article of the present invention is made by a process wherein a dip-formed layer is formed on a dip-forming form by using a water-soluble polyvalent metal salt as a coagulant for latex; and the dip-formed layer is dried, and then released from the dip-forming form.

More specifically the formation of the dip-formed layer on a dip-forming form is carried out by (i) an anode cohesion dip-forming method wherein a dip-forming form is dipped in a liquid containing a water-soluble polyvalent metal salt as a coagulant for latex, to form a layer comprised of the coagulant-containing liquid on the form, and then, the form having the coagulant-containing liquid formed thereon is dipped in the dip-forming composition of the present invention; or (ii) a Teague cohesion dip-forming method wherein a dip-forming form is dipped in the dip-forming composition of the present invention to form a layer of the dip-forming composition on the form, and then, the form having the layer of the dip-forming composition formed thereon is dipped in a liquid containing a water-soluble polyvalent metal salt as a coagulant for latex.

Each of the anode cohesion dip-forming method and the Teague cohesion dip-forming method can be repeated or a combination of the two methods can be employed to make a thick dip-formed article. Of the two dip-forming methods, the anode cohesion dip-forming method is preferable because a dip-formed article having a uniform thickness can be obtained.

The water-soluble polyvalent metal salt used as a coagulant for latex has a solubility in water at 25° C. of at least 5 parts by weight, preferably at least 20 parts by weight, per 100 parts by weight of water, and is a salt of a metal selected from the group consisting of the metals in group 2, group 12 and group 13 of the periodic table. The water-soluble polyvalent metal salt has a function of lowering the stability of latex particles dispersed in an aqueous phase and coagulating the latex particles.

As specific examples of the water-soluble polyvalent metal salt, there can be mentioned metal halides such as barium chloride, calcium chloride, magnesium chloride, zinc chloride and aluminum chloride; metal nitrates such as barium nitrate, calcium nitrate and zinc nitrate; metal acetates such as barium acetate, calcium acetate and zinc acetate; and metal sulfates such as calcium sulfate, magnesium sulfate and aluminum sulfate. Of these, calcium chloride and calcium nitrate are preferable. These water-soluble polyvalent metal salts are preferably used in an aqueous solution form. The concentration of the aqueous solution varies depending upon the particular kind of the water-soluble polyvalent metal salt, but is usually in the range of 5 to 70% by weight, preferably 20 to 50% by weight. The aqueous solution is usually used at a temperature of 0 to 90° C., preferably 30 to 70° C.

The dip-forming form and the dip-forming composition are usually used at a temperature in the range of room temperature to 90° C., preferably 40 to 80° C. The time for which the dip-forming form is dipped in a liquid containing a coagulant for latex, and the time for which the dip-forming form having deposited thereon the coagulant for latex is dipped in the dip-forming composition may be chosen so that a dip-formed layer having a desired thickness is obtained.

The dip-formed wet layer can be dipped in water, preferably warm water maintained at a temperature of 40 to 70° C., for 2 to 60 minutes, prior to drying, to remove water-soluble impurities such as excessive emulsifier and water-soluble polyvalent metal. This impurity-removing procedure can be carried out after the dip-formed wet layer is dried, but is preferably carried out before it is dried, for removing the water-soluble impurities with enhanced efficiency. This impurity-removal results in a dip-formed article having enhanced tensile strength.

The thus-formed dip-formed layer has a high water content and therefore must be dried. The drying is carried out to an extent such that the water content is reduced to preferably not larger than 5% by weight, more preferably not larger than 2% by weight. An external heating method using infrared rays or hot air, or an internal heating method using high frequency can be adopted for drying. Of these, hot air drying is preferable. The drying temperature is usually in the range of 60 to 95° C., preferably 70 to 85° C., and the drying time is usually in the range of about 10 to 120 minutes.

By drying the dip-formed layer, high tensile strength is given to the dip-formed layer, and a dip-formed article can be released from a dip-forming form. The release can be carried out manually or applying water pressure or compressed air.

Prior to the release from the form, the dried dip-formed layer can be heat-treated at a temperature in the range of 100 to 150° C. for about 10 to 120 minutes. But, a dip-formed article having a sufficiently high strength can be obtained from the dip-forming composition of the present invention without the heat-treatment. If desired, the dip-formed article can be further heat-treated at a temperature in the range of 60 to 120° C. for about 10 to 120 minutes after it is released from the form.

The thus-obtained dip-formed article preferably has a tensile stress of smaller than 3.5 MPa, more preferably smaller than 3.0 MPa and especially preferably smaller than 2.5 MPa, at 300% elongation. If the tensile stress is too large, the dip-formed article has poor softness to touch and poor comfortable fittingness.

The dip-formed article preferably has a tensile strength of at least 10 MPa, more preferably at least 15 MPa and especially preferably at least 20 MPa.

In the case where the dip-formed article is a glove, a surface coating layer may be formed on the inner surface and/or the outer surface of the glove so that the glove can be easily put on and pulled off.

### EXAMPLES

The invention will now be described by the following examples wherein % and parts are by weight unless otherwise specified.

Properties of a copolymer latex, a dip-forming composition and a dip-formed article were evaluated by the following methods.

I. Properties of Copolymer and Dip-Forming Composition

(1) pH Value of Copolymer Latex and Dip-Forming Composition pH values of a copolymer latex and a dip-forming composition were measured at 25° C. by a pH meter (“M12” available from HORIBA Co.).

(2) Content (%) Insoluble in Methyl Ethyl Ketone of Copolymer

A copolymer latex having a pH value of 10 and a solid content of 30% was prepared by adding an aqueous 5% potassium hydroxide solution. The copolymer latex was cast on a glass sheet with a frame, and allowed to stand at a temperature of 23° C. and a relative humidity of 50% for 48 hours to give a dry film having a thickness of 1 mm.

0.3 g of the dry film was placed in a wire mesh cage with 80 mesh, and the cage was immersed in a bath of 100 ml of methyl ethyl ketone (MEK) at a temperature of 20° C. for 48 hours. The residual film undissolved in MEK was dried under a reduced pressure at a temperature of 20° C. The content insoluble in MEK was expressed by the residual % of film undissolved in MEK based on the weight of film as measured before immersion in MEK.

II. Properties of Dip-Formed Article

Preparation of Test Specimen

A dumbbell specimen was punched out from a dip-formed article of a glove form by a dumbbell die “Die-C” according to ASTM D412.

(1) Tensile Stress (MPa) at 300% Elongation

A specimen was drawn at a drawing rate of 500 mm/min by Tensilon tensile tester (“RTC-1225A” available from Orientec Co.). Tensile stress was measured at an elongation of 300%. The smaller the tensile stress, the better the softness of touch and comfortable fittingness of glove.

(2) Tensile Strength (MPa)

A specimen was drawn at a drawing rate of 500 mm/min by Tensilon tensile tester, and tensile strength was measured immediately before breaking.

(3) Elongation at Break (%)

A specimen was drawn at a drawing rate of 500 mm/min by Tensilon tensile tester, and elongation was measured immediately before breaking.

(4) Fatigue Resistance to Repeated Use

Stretching of a specimen to 200% elongation was repeated at a temperature of 25° C. at 200 times per minute by a constant tensile fatigue tester (“FT1501” available from Ueshima Manufacturing Co.). The number of repeated stretching at break was measured. The test was conducted ten times. The largest number and the smallest number were excluded, and an average number of repeated stretching was calculated from eight numbers.

In the case when the fatigue resistance as measured on a glove is not larger than about 100,000 times, when the glove is worn while fingers are moved, fine cracks occur at finger crotches in about 1 to 2 hours.

(5) Number of Pinholes

A dip-formed article in a glove form was filled with water, and, when 30 minutes elapsed, the number of pinholes on which water leaking was observed was counted. This test was conducted on 100 glove specimens, and the total number of pinholes in the ten specimens was measured.

Production Example 1

A polymerization vessel, flushed with nitrogen, was charged with 28 parts of acrylonitrile, 66 parts of 1,3-butadiene, 6 parts of methacrylic acid, 0.3 part of tert-dodecyl mercaptan (TDM), 132 parts of soft water, 3.0 parts of sodium dodecylbenzenesulfonate, 0.5 parts of sodium salt of β-naphthalenesulfonic acid-formaldehyde condensate, 0.3 part of potassium persulfate and 0.05 part of sodium ethylenediaminetetraacetate. Then the temperature of the content was elevated to 37° C. to initiate polymerization.

When the polymerization conversion of the total monomers reached 60%, 0.15 part of tert-dodecyl mercaptan was added and the polymerization temperature was elevated to 40° C. When the polymerization conversion reached 80%, 0.15 part of tert-dodecyl mercaptan was added to continue polymerization until the polymerization reached 94%. Then 0.1 part of sodium dimethyldithiocarbamate as a polymerization stopper was added to terminate polymerization.

Unreacted monomers were removed from the thus-prepared copolymer latex, and then, the pH value and solid content of the copolymer latex were adjusted to give a copolymer latex A having a solid content of 40% and a pH value of 8.

A part of the copolymer latex A was taken, and its content insoluble in methyl ethyl ketone was measured. The results are shown in Table 1.

Production Examples 2 and 3

By the same procedures as described in Production Example 1, copolymer latex B and copolymer latex C were prepared wherein the monomer composition, the amount of TDM and the conditions under which TDM was added were varied as shown in Table 1. All other conditions remained the same. The contents insoluble in methyl ethyl ketone were measured. The results are shown in Table 1.

TABLE 1

| | Production Examples | | |
|---|---|---|---|
| | 1 | 2 | 3 |
| Copolymer latex | A | B | C |
| Initially charged ingredients | | | |
| Monomer composition (parts) | | | |
| 1,3-butadiene | 66 | 74 | 66 |
| Acrylonitrile | 28 | 22 | 28 |
| Methacrylic acid | 6 | 4 | 6 |
| Molecular weight modifier (parts) | | | |
| tert-dodecyl mercaptan (TDM) | 0.3 | 0.3 | 0.6 |
| Amount of TDM added after commencement | | | |
| of polymerization (parts) | | | |
| at polymerization conversion of 60% | 0.15 | 0.15 | — |
| at polymerization conversion of 80% | 0.15 | 0.15 | — |
| Property of copolymer | | | |
| Content insoluble in MEK (%) | 2 | 1 | 56 |

### Example 1

An aqueous 5% potassium hydroxide solution was added to copolymer latex A to give a dip-forming composition having a pH value of 11 and a solid content of 30%.

An aqueous latex-coagulating solution was prepared by mixing together 20 parts of calcium nitrate as a water-soluble polyvalent metal salt, 0.05 part of a nonionic emulsifier (“Emulgen-810™” available from Kao Corporation) and 80 parts of water. A dip-forming glove form, maintained at 600° C., was dipped in a bath of the aqueous coagulating solution for 10 seconds, and then taken from the bath and dried at 60° C. for 10 minutes whereby the water-soluble polyvalent metal salt was deposited on the surface of glove form.

The glove form having deposited thereon the water-soluble polyvalent metal salt was dipped in a bath of the dip-forming composition comprising copolymer latex A for 15 seconds, and then taken from the bath to form a dip-formed layer on the glove form. Then the glove form having the dip-formed layer was dipped in distilled water, maintained at 40° C., for 5 minutes to remove water-soluble impurities. Then the glove form having the dip-formed layer was pre-dried at 20° C. for 5 minutes, dried at 80° C. for 20 minutes, and then heat-treated at 120° C. for 20 minutes whereby the dip-formed layer on the glove form was changed to a solid film layer. Finally the solid film layer was released from the glove form to give a dip-formed article of glove form having a thickness of 0.1 to 0.2 mm. Properties of the dip-formed article are shown in Table 2.

### Example 2

By the same procedures as described in Example 1, a dip-formed article of glove form was made wherein copolymer latex B was used instead of copolymer latex A with all other conditions remaining the same. Properties of the dip-formed article are shown in Table 2.

### Example 3

By the same procedures as described in Example 1, a dip-formed article of glove form was made wherein a mixture of copolymer latex A with copolymer latex C (mixed ratio of solid content: A/C=90/10) was used instead of copolymer latex A. All other conditions remained the same. Properties of the dip-formed article are shown in Table 2.

The total copolymers in the copolymer latex mixture exhibited a content insoluble in MEK of 5%.

### Example 4

By the same procedures as described in Example 1, a dip-formed article of glove form was made wherein a mixture of copolymer latex B with copolymer latex C (mixed ratio of solid content: B/C=90/10) was used instead of copolymer latex A. All other conditions remained the same. Properties of the dip-formed article are shown in Table 2.

The total copolymers in the copolymer latex mixture exhibited a content insoluble in MEK of 4%.

### Comparative Example 1

An aqueous vulcanizer dispersion was prepared by mixing together 1 part of zinc dibutylcarbamate, 1 part of sulfur, 1.5 parts of zinc oxide, 0.5 part of an aqueous 40% solution of sodium salt of β-naphthalenesulfonic acid-formaldehyde condensate, and 4 parts of water by a ball mill. 8 parts of the aqueous vulcanizer dispersion was mixed with 250 parts of copolymer latex A (solid content: 100 parts). Then, an aqueous 5% potassium hydroxide solution was added to the aqueous vulcanizer/-copolymer latex A mixture to give a dip-forming composition having a pH value of 10 and a solid content of 30%. The dip-forming composition was aged for one day, and then, a dip-formed article of glove form was made from the aged dip-forming composition by the same procedures as described in Example 1 except that heat-vulcanization at 120° C. for 25 minutes was conducted instead of drying at 80° C. for 20 minutes. Properties of the dip-formed article are shown in Table 2.

### Comparative Example 2

An aqueous vulcanizer dispersion was prepared by mixing together 1 part of zinc dibutylcarbamate, 1 part of sulfur, 0.5 part of an aqueous 40% solution of sodium salt of β-naphthalenesulfonic acid-formaldehyde condensate, and 2.5 parts of water by a ball mill. 5 parts of the aqueous vulcanizer dispersion was mixed with 250 parts of copolymer latex A (solid content: 100 parts). Then, an aqueous 5% potassium hydroxide solution was added to the aqueous vulcanizer/copolymer latex A mixture to give a dip-forming composition having a pH value of 10 and a solid content of 30%. The dip-forming composition was aged for one day, and then, a dip-formed article of glove form was made from the aged dip-forming composition by the same procedures as described in Comparative Example 1. Properties of the dip-formed article are shown in Table 2.

### Comparative Example 3

An aqueous zinc oxide dispersion was prepared by mixing together 1.5 parts of zinc oxide, 0.5 part of an aqueous 40% solution of sodium salt of β-naphthalenesulfonic acid- formaldehyde condensate, and 2 parts of water by a ball mill. 4 parts of the aqueous zinc oxide dispersion was mixed with 250 parts of copolymer latex A (solid content: 100 parts). Then, an aqueous 5% potassium hydroxide solution was added to the aqueous zinc oxide/copolymer latex A mixture to give a dip-forming composition having a pH value of 10 and a solid content of 30%. The dip-forming composition was aged for one day, and then, a dip-formed article of glove form was made from the aged dip-forming composition by the same procedures as described in Comparative Example 1. Properties of the dip-formed article are shown in Table 2.

### Comparative Example 4

By the same procedures as described in Example 1, a dip-formed article of glove form was made from a dip-forming composition having a pH value of 11 and a solid content of 30% wherein the dip-forming composition was prepared by adding an aqueous 5% potassium hydroxide solution to copolymer latex C. All other conditions remained the same. Properties of the dip-formed article are shown in Table 2.

### Comparative Example 5

By the same procedures as described in Example 1, a dip-formed article of glove form was made wherein a dip-forming composition having a pH value of 8 and a solid content of 30%, prepared from copolymer latex A, was used. All other conditions remained the same. Properties of the dip-formed article are shown in Table 2.

In this comparative example, when a dip-formed solid film layer was released from a glove form, the solid film layer was easily elongated and broken. Therefore, a satisfactory dip-formed article of glove form could not be obtained.

TABLE 1

| | Examples | | | | Comparative Examples | | | | |
|---|---|---|---|---|---|---|---|---|---|
| | 1 | 2 | 3 | 4 | 1 | 2 | 3 | 4 | 5 |
| Dip-forming Composition | | | | | | | | | |
| Copolymer latex | A | B | A/C | B/C | A | A | A | C | A |
| | | | (90/10) | (90/10) | | | | | |
| Sulfur | — | — | — | — | 1 | 1 | — | — | — |
| Vulc. accelerator | — | — | — | — | 1 | 1 | — | — | — |
| Zinc oxide | — | — | — | — | 1.5 | — | 1.5 | — | — |
| pH value of dip-forming composition | 11 | 11 | 11 | 11 | 10 | 10 | 10 | 11 | 8 |
| Properties of dip-formed article | | | | | | | | | |
| Tensile strength (MPa) | 32.5 | 27.6 | 29.6 | 28.5 | 26.5 | 24.6 | 25.3 | 25.4 | 8.7 |
| 300% Tensile stress (MPa) | 2.5 | 2.3 | 2.6 | 2.5 | 5.3 | 3.1 | 4.6 | 3.2 | 1.2 |
| Breaking elongation (%) | 600 | 620 | 630 | 600 | 530 | 570 | 590 | 530 | 820 |
| Fatigue resistance (times × 10³) | 358 | 325 | 346 | 317 | 297 | 337 | 243 | 68 | — |
| Pinholes (number) | 1 | 1 | 2 | 1 | 29 | 20 | 23 | 2 | — |

The following will be seen from Table 2.

The dip-formed article made from a composition containing sulfur, a vulcanization accelerator and zinc oxide has poor softness to touch and poor fittingness, and many pinholes (Comparative Example 1).

The dip-formed article made from a composition containing sulfur and a vulcanization accelerator exhibits fairly good softness to touch and comfortable fittingness, but has many pinholes (Comparative Example 2).

The dip-formed article made from a composition comprising copolymer latex C having a larger content soluble in methyl ethyl ketone than that used in the present invention has a reduced number of pinholes and good softness to touch and good comfortable fittingness, but poor fatigue resistance to repeated use (Comparative Example 4).

The dip-formed article made from a composition having a pH value lower than that used in the present invention has good softness to touch and comfortable fittingness, but too low tensile strength to be a satisfactory dip-formed article (Comparative Example 5).

In contrast, the dip-formed articles of the present invention have an extremely reduced number of pinholes and are excellent in softness to touch, comfortable fittingness, tensile strength and fatigue resistance to repeated use (Examples 1 to 4). The dip-forming composition of the present invention can give a dip-formed article having satisfactory properties, even when the composition is not aged before the dip-forming.

### INDUSTRIAL APPLICABILITY

The dip-forming composition of the present invention gives a dip-formed article having an extremely reduced number of pinholes, exhibiting good softness of touch and comfortable fittingness, and having high tensile strength and fatigue resistance to repeated use. This dip-formed article can have a thickness of about 0.1 mm to about 3 mm. Especially a thin dip-formed article having a thickness of 0.1 to 0.3 mm can be made.

Thus the dip-formed article of the present invention having the above characteristics is suitable for, for example, a nipple of nursing bottle, medical articles such as a dropper, a duct and a water pillow; toys such as a balloon, dolls and a ball, and sporting goods such as a ball; industrial articles such as a pressure molding bag and a gas storage bag; unsupported gloves and supported gloves for surgical, household, agricultural, fishery and industrial uses; and a finger cot. The dip-formed article is especially advantageously used as thin gloves such as thin surgical gloves.

1. A dip-formed article comprising a crosslinked dip-forming composition,
wherein the dip-forming composition comprises a conjugated diene rubber latex prepared by copolymerizing, based on the weight of total monomers, 30 to 90% by weight of a conjugated diene monomer, 0.1 to 20% by weight of an ethylenically unsaturated acid monomer and 0 to 69.9% by weight of other ethylenically unsaturated monomer copolymerizable therewith, wherein a copolymer constituting the conjugated diene rubber latex exhibits a content insoluble in methyl ethyl ketone of not larger than 30% by weight at a latex pH value of 10, and the dip-forming composition has a pH value of at least 8.5 and is substantially free from a sulfur-containing vulcanizer, a vulcanization accelerator for the sulfur-containing vulcanizer, and zinc oxide,
wherein said dip-forming composition has been crosslinked with a water-soluble polyvalent metal salt used as a coagulant for latex.

2. The dip-formed article according to claim 1, wherein the water-soluble polyvalent metal salt has a solubility in water at 25° C. of at least 5 parts by weight per 100 parts by weight of water, and is a salt of a metal selected from the group consisting of the metals in group 2, group 12 and group 13 of the periodic table.

3. The dip-formed article according to claim 1, which has a tensile stress of smaller than 3.5 MPa at 300% elongation, and a tensile strength of at least 10 MPa.

4. A process for making a dip-formed article comprising the steps of:
(1) forming a dip-formed layer on a dip-forming form from a dip-forming composition by carrying out (i) at least one step of dipping a dip-forming form in a liquid containing a water-soluble polyvalent metal salt as a coagulant for latex, to form a layer comprised of the coagulant-containing liquid on the form, and then, dipping the form having the coagulant-containing liquid thereon in said dip-forming composition; or (ii) at least one step of dipping a dip-forming form in said dip-forming composition to form a layer of the dip-forming composition on the form, and then, dipping the form having the layer of the dip-forming composition thereon in a liquid containing a water-soluble polyvalent metal salt as a coagulant for latex; or (iii) a combination of said step (i) with said step (ii);
(2) drying the dip-formed layer formed on the form; and then,
(3) releasing the dried dip-formed layer from the form, wherein the dip-forming composition comprises a conjugated diene rubber latex prepared by copolymerizing, based on the weight of total monomers, 30 to 90% by weight of a conjugated diene monomer, 0.1 to 20% by weight of an ethylenically unsaturated acid monomer and 0 to 69.9% by weight of other ethylenically unsaturated monomer copolymerizable therewith, wherein a copolymer constituting the conjugated diene rubber latex exhibits a content insoluble in methyl ethyl ketone of not larger than 30% by weight at a latex pH value of 10, and the dip-forming composition has a pH value of at least 8.5 and is substantially free from a sulfur-containing vulcanizer, a vulcanization accelerator for the sulfur-containing vulcanizer, and zinc oxide.

5. The process for making a dip-formed article according to claim 4, wherein the step (1) of forming a dip-formed layer on the dip-forming form is carried out at a temperature in the range of room temperature to 90° C., and the step (2) of drying the dip-formed layer is carried out at a temperature in the range of 60 to 95° C.

6. The process for making a dip-formed article according to claim 4, wherein the dip-formed layer of said dip-forming composition is formed on a dip-forming form by carrying out at least one step (i) of dipping the dip-forming form in a liquid containing a water-soluble polyvalent metal salt as a coagulant for latex, to form a layer comprised of the coagulant-containing liquid on the form, and then, dipping the form having the coagulant-containing liquid thereon in said dip-forming composition.
